(19) United States
(12) Patent Application Publication
(10) Pub. No.: US 2015/0123379 A1
(43) Pub. Date: May 7, 2015

(54) TRAILER COUPLER LOCKING DEVICE

(71) Applicant: Guoji Yuan, Foshan (CN)

(72) Inventor: Guoji Yuan, Foshan (CN)

(21) Appl. No.: 14/530,742

(22) Filed: Nov. 1, 2014

Related U.S. Application Data
(60) Provisional application No. 61/899,115, filed on Nov. 1, 2013.

(51) Int. Cl. B60D 1/60; B60D 1/06

(52) U.S. Cl. CPC B60D 1/60; B60D 1/06
USPC 280/507

(57) ABSTRACT

A locking device for obstructing towing of a trailer has a lock base and a lock bracket. The lock base has an upright ball-shaped member and two legs each with an aperture. The lock bracket has two arms. When the locking device is in a locked condition, both arms are engaged in their corresponding apertures. When the locking device is in an unlocked condition, one arm of the lock bracket remains attached to its corresponding aperture, and the other arm is removed from the other aperture to release the coupler. Grooves on one of the arms allow a locking means to engage with the lock bracket at different height. In another aspect of the invention, the ball member is detachable and can be replaced by different sized ball member so that the same locking device can be used on trailer couplers with different socket sizes.

### CROSS-REFERENCE TO RELATED APPLICATIONS

This application claims priority to Provisional U.S. Patent Application No. 61/899,115, filed Nov. 1, 2013, the entirety of which is incorporated by reference herein.

### FIELD OF INVENTION

The present invention relates to an anti-theft locking device used on a trailer hitch coupler to obstruct towing of an unattached trailer. More particularly, the present invention provides structural improvements over the conventional trailer locking devices.

### BACKGROUND OF THE INVENTION

Use of trailers towed by various vehicles on the ground or in the water for storing and transporting goods in both domestic and industrial applications is well-known in the field. A typical trailer application may include a hitch mounted on a vehicle with a receiver for receiving a ball mount assembly and a coupler on a trailer with a socket for linking the trailer to the hitch through the ball mount assembly. When the trailer is not towed or not connected to the vehicle, it can be easily hitched up to another ball mount through the trailer's coupler front end and towed away by an unauthorized person. There is a recognized need for providing a security device such as a lock for blocking trailer coupler from being attached to a ball mount in order to prevent unauthorized removal of the trailer while the trailer is not in active use.

The above problem has been recognized in the art and various approaches have been attempted to address the issue. These include those described in U.S. Pat. Nos. 6,666,051, 6,722,686, 7,121,121, and U.S. Publication No 2005/0039498.

U.S. Pat. No. 6,722,686 provides a coupler lock with a removable U-shaped lock bar to engage with a lock housing having a ball-shaped dome to be attached to a trailer coupler socket so that the U-shaped lock bar is fastened over the trailer coupler to obstruct engagement between a hitch ball and the trailer couple socket. U.S. Pat. Nos. 6,666,051, 7,121,121, and U.S. Pub No. 2005/0039498 teach similar techniques of locking a trailer hitch coupler using a removable lock bar fastened to a lock housing having a ball-shaped member. Each of those devices requires the lock bar to be completely released from two apertures in the lock base in order to attach or detach the ball-shaped member to or from the coupler socket. Therefore, the lock bar may not be coupled to the lock housing when the device is not in use, which raises the issue of the lock bar being misplaced or lost. Further, each of those ball-shaped members on a lock base bears a fixed size or shape and is non-removable. Trailer couplers with various socket sizes may be used for different trailers. Locking devices with different sizes of ball-shaped members have to be selected for locking trailer couplers that vary in socket sizes. Therefore, one coupler lock having a fixed sized ball-shaped member may not be used interchangeably on various trailer couplers having different socket sizes.

### SUMMARY OF THE INVENTION

The locking device of the present invention overcomes the disadvantages of the prior art devices by providing a locking device having a lock bracket always attached to a lock base and an interchangeable ball-shaped member screwed on the lock base.

The locking device of the present invention has a lock base and a lock bracket. The lock base has an upright ball-shaped member and two legs each with an aperture. The lock bracket has two arms. When the locking device is in a locked condition, the lock bracket is placed over the ball-shaped member and both arms are engaged in their corresponding apertures to interlock with a coupler. When the locking device is in an unlocked condition, one arm of the lock bracket remains attached to its corresponding aperture, and the other arm is removed from the other aperture and rotated away from the ball-shaped member to release the coupler.

The locking device of the present invention may further feature a lock base having a cylindrical leg at each side of the base. Each cylindrical leg has an aperture, which may be a through aperture. The aperture on one of the cylindrical legs may have different diameters at two openings.

The locking device of the present invention may further feature a lock bracket having two arms. One arm is permanently attached to the aperture of one leg of the lock base; Whereas the other arm can slide into or completely slide out of the aperture of the other leg and can fit a trailer coupler at various height.

The locking device of the present invention may further feature a lock bracket having two arms with one arm having a spiral groove, parallel grooves, parallel notches or holes.

The locking device of the present invention may further feature a retrieve pin having a notched shape on one end and an enlarged forged-cap shape on the other end. The notched end of the retrieve pin may have punctures to adopt a rivet.

The locking device of the present invention may further feature a lock bracket having two arms with one arm has an insertion end. The insertion end may be flattened from both sides and have a puncture in the center. The notched end of the retrieve pin may sandwich the insertion end of the lock bracket.

The locking device of the present invention may further feature a rivet that links and fastens the lock bracket and the retrieve pin by puncturing through the notched end of the retrieve pin and the insertion end of the lock bracket that is inserted in the notched end of the retrieve pin.

The locking device of the present invention may also feature a locking mechanism that tracks or retracts a locking bolt to engage or disengage with the grooved arm of the lock bracket.

The locking device of the present invention may also feature a detachable ball shaped member. For using the locking device on trailer couplers with different socket sizes, interchangeable hitch balls having industrial standard sizes may be selected and screwed or bolted onto the lock base.

### BRIEF DESCRIPTION OF THE DRAWINGS

The accompanying drawings, which are incorporated in and constitute a part of the specification, illustrate embodiments of the invention and together with the description, serve to explain the principles and structures of the invention.

FIG. 1 illustrates the main components of a trailer locking device in a disassembled state according to one preferred embodiment of the present invention.

FIG. 2 illustrates a trailer locking device with the lock bracket in an open position according to one preferred embodiment of the present invention.

FIG. 3 illustrates a trailer locking device with the lock bracket in a closed position according to one preferred embodiment of the present invention.

FIG. 4 illustrates a trailer locking device with the lock bracket being pushed down all the way through the apertures of the cylindrical legs according to one preferred embodiment of the present invention.

FIG. 5 is a perspective drawing of a trailer locking device illustrating the grooved arm of the lock bracket being lifted out of the aperture according to one preferred embodiment of the present invention.

FIG. 6 is a perspective drawing of a trailer locking device illustrating the grooved arm of the lock bracket being pushed into the aperture according to one preferred embodiment of the present invention.

### DETAILED DESCRIPTION OF THE INVENTION

The locking device of the present invention is designed to be used with a towing coupler. A towing coupler, also known as a trailer coupler, is a device attached to an object being towed. During towing, the towing coupler is matched with a tow hitch installed on a vehicle. The object being towed is commonly referred as a trailer. The object being towed may be but not limited to a travel trailer, a bike trailer, a boat trailer, a single-axle dolly, a multiple-axle dolly, a semi-trailer truck, a popup camper, and a mobile home. When the object is not being towed, the locking device may be applied to the towing coupler in order to obstruct an unauthorized towing.

Reference is now made in detail to the exemplary embodiments of the invention, examples of which are illustrated in the accompanying drawings. Wherever possible, the same reference numbers will be used throughout the drawings to refer to the same or like parts. The description, embodiments and figures are not to be taken as limiting the scope of the claims.

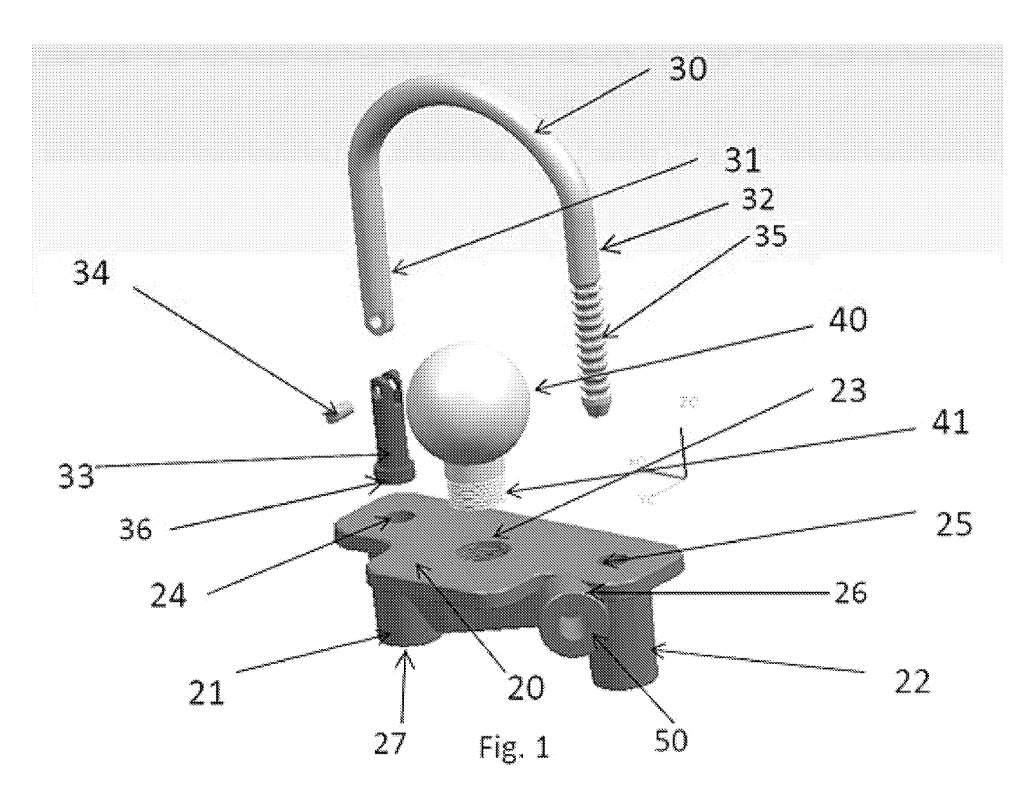

FIG. 1 illustrates the main components of a trailer locking device in a disassembled state according to one preferred embodiment of the present invention. The trailer locking device as described in FIG. 1, mainly includes a base (20), a threaded opening (23) positioned relatively at center of the base, a detachable hitch ball (40) sized to match a coupler socket screwed into the threaded opening erecting upright from the top surface of the base, two cylindrical legs (21, 22) with two open apertures (24, 25) symmetrically positioned on two sides of the base extending downward from the bottom surface of the base, a lock housing (26) adjacent to the cylindrical leg (22) enclosing a locking means (50), a U-shaped lock bracket (30) having two arms (31, 32). One arm (31) is linked to the base (20) via an anchoring device. In one preferred embodiment, the anchoring device includes a retrieve bin (33) as illustrated in FIG. 1. The arm (31) is linked by a rivet (34) to the retrieve pin (33) anchored in the aperture of cylindrical leg (21). The other arm (32) with grooves (35) is to be inserted into the cylindrical leg (22) through the aperture opening (25) and is to be engaged with a lock component of the locking means (50).

In a preferred embodiment, the lock base (20) as illustrated in FIG. 1 is a one-piece or an integrated piece boring several openings. The opening (23) with inner threads centered substantially at the base may have a diameter of industrial standard size that allows a hitch ball to be screwed in. Hitch balls of different sizes can be interchangeably screwed in the based opening (23) to accommodate trailer couplers having various socket sizes. Alternatively, proprietary ball-shaped members may be used interchangeably to accommodate trailer couplers having various socket sizes.

Two cylindrical legs (21, 22) may be substantially symmetrically apart from the ball shaped member. In an alternative embodiment, the cylindrical legs (21, 22) may also extend upward from the top main surface of the lock base (20). As shown in FIG. 1, the leg (21, 22) is substantially cylindrical with a rounded cross-section view. Alternatively, the leg (21, 22) may have a polygon shape at a cross-section view.

Two apertures (24, 25) run lengthwise along the corresponding cylindrical legs. Any one of the apertures (24, 25) may run through the two cylindrical legs in some embodiments and may not run through (may have a sealed bottom) in other embodiments. In one preferred embodiment as illustrated in FIG. 1, the two apertures run through the two cylindrical legs and the through aperture (24) has an opening (27) on the bottom side of the leg (21). Each of the two apertures (24, 25) has a diameter wide enough to allow the corresponding arm of U-shaped bracket to slide into. An internal blocking ring (not shown in FIG. 1) is machined on the aperture (24) close to the top surface of the lock base. The internal blocking ring reduces the inner diameter of the aperture near the top surface of the lock base and prevents the forged-cap end of the retrieve pin from completely sliding out of the aperture. Alternatively, the aperture (24) may have different internal diameters at the different sections: The diameter of the aperture (24) near the top surface of the base could be machined smaller than that of the forged-cap end of the retrieve pin in order to stop the retrieve pin from being released from the aperture (24) completely.

The lock housing located adjacent to the cylindrical leg (22) shelters a lock means. The lock means may extend a lock component, e.g. a lock bolt, into the aperture of the cylindrical leg (22) to be engaged with a groove on the arm (32) of the U-shaped bracket that has descended from the aperture opening. The lock means may be a mechanical lock or an electrical lock.

The curvature bracket is bent into a U-shape with two arms extending in the same direction. The arms are capable of sliding through the apertures of cylindrical legs. One arm (32) of the U-shaped bracket with grooves would interlock at various positions with a locking component from the locking means while sliding along the aperture of a cylindrical leg. A spiral groove may be etched or mechanically grooved onto the arm (32). The continuity of the spiral groove allows the locking bolt to engage with the arm at various positions so that the height of the U-shaped bracket is adjustable. Alternatively, a number of parallel grooves other than a spiral groove may be etched or mechanically grooved onto the arm (32). For example, a series of ring grooves, a series of parallel notches, or a series of holes may be engraved or drilled on the arm (32). The grooves, notches, or holes allow the locking component to engage with the arm at various heights while the arm is sliding through the aperture of a cylindrical leg so as to adjust the height of the U-shaped bracket. Alternatively, the locking component may use a pawl, a locking ball, or a locking bin in lieu of the locking bolt. The grooved arm (32) may have a series of notches that resembles teeth to be latched with a pawl in one direction. When the pawl is retracted, the grooved arm is free to slide in both directions. When the pawl is released, the grooved arm can only slide in one direction that would tighten the closed lock bracket.

The other arm (31) of the U-shaped bracket links with a retrieve pin (33) by a rivet (34). The retrieve pin has one end cut into a notched shape in order to sandwich the flattened end of the arm (31). The other end of the retrieve pin is forged into a cap shape. The cap shape have a diameter smaller than the through aperture opening (27) but larger than the aperture (24) opening at the top end of the cylindrical leg (21). So the retrieve pin can slide along the internal channel of the cylindrical leg (21) and can pass through the aperture opening (27) at the end of the cylindrical leg (21), but cannot completely pass through the aperture (24) opening at the top surface of the base. The end of the arm (31) is flattened from both sides towards the center so that the flattened end can be inserted into the notched end of the retrieve pin. Through holes may be punctured on the insertion end of the arm (31) and on the notched end of the retrieve pin to allow a rivet to pass through so as to link the insertion end of the arm and the retrieve pin.

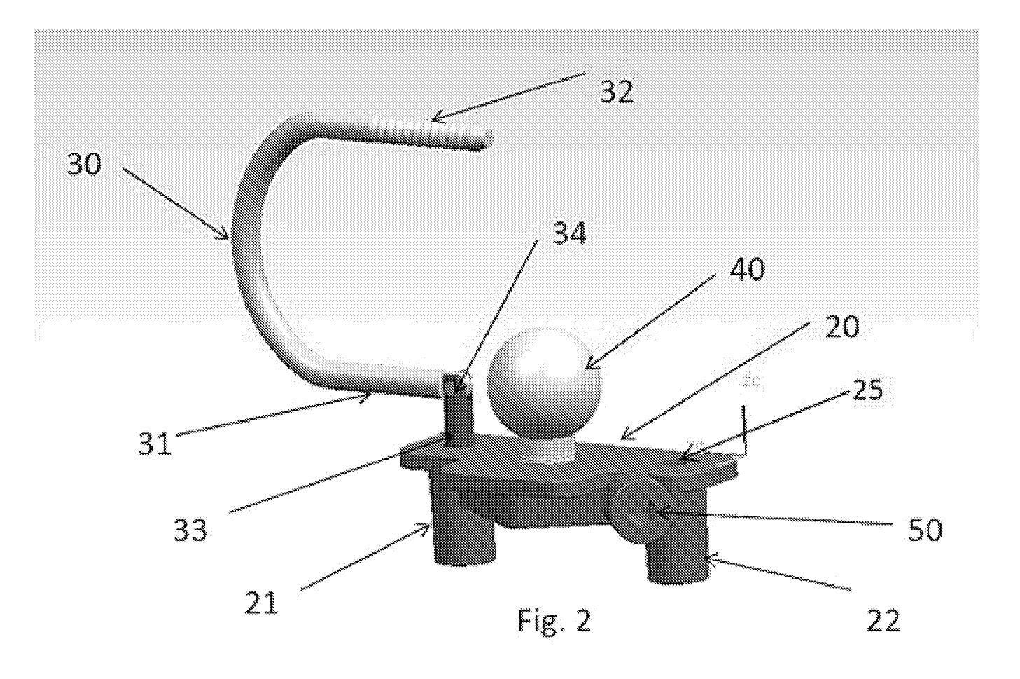

FIG. 2 illustrates the trailer locking device in an unlocked condition with the lock bracket in an open position according to one preferred embodiment of the present invention. Once the lock bolt is released to free the grooved arm (32), the whole lock bracket can be lifted upward through the apertures (24) and (25) to a point that the grooved arm (32) disengages completely from the aperture (25) whereas the arm (31) is stopped moving upward by the forged-cap end (36) of the retrieve pin (33). After the grooved arm (32) disengages completely from the aperture (25), the rivet (34) allows the lock bracket to rotate aside in order to open up the space above the ball-shaped member. Upon the implementation, the maximum rotation may be around 90 degrees or close to 180 degrees. This gives ample room for a trailer coupler socket to be seated onto or removed from the ball-shaped member while the lock bracket never separates from the lock base.

Most common industrial standard trailer hitch ball sizes includes 1⅞″, 2″, and 2 5/16″. Trailer hitch couplers are made to fit particular hitch ball sizes. In order to accommodate various socket sizes of couplers, the coupler locking device may feature a detachable ball-shaped member (40) with a thread (41) to be screwed into the mounting hole (23) in the lock base (20). For the same locking device to be used on different trailer hitch couplers, different sized ball-shaped member may be interchangeably screwed onto the lock base without replacing the lock base. Alternatively the hitch ball may fastened to the lock base (20) using other means, such as being bolted on by a nut.

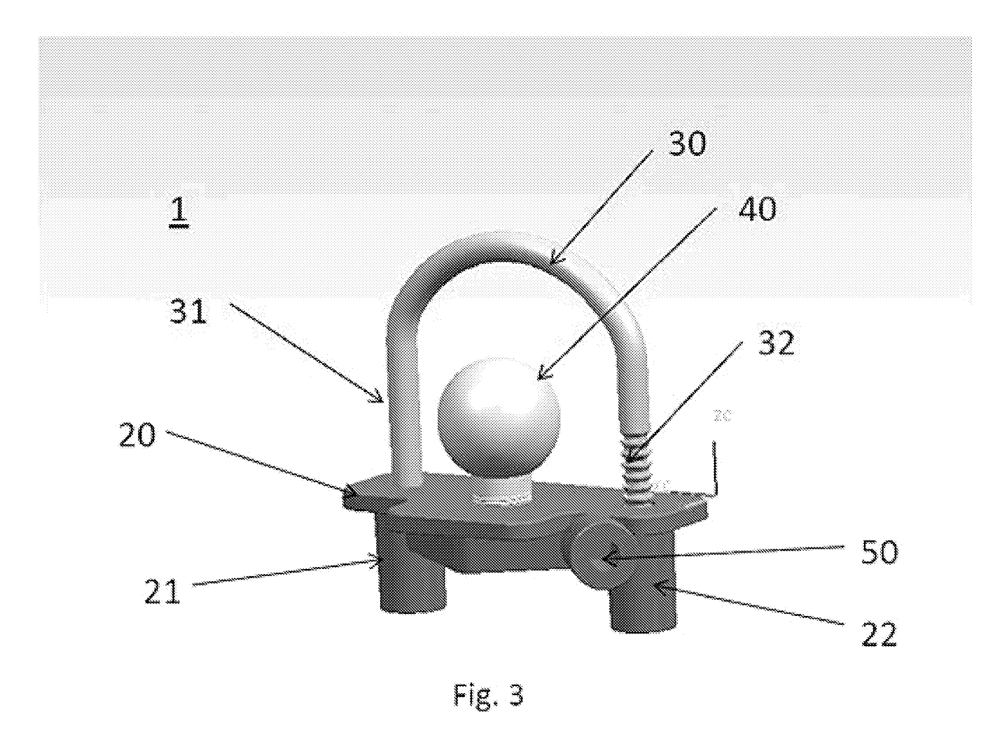

FIG. 3 illustrates a trailer locking device with the lock bracket in a closed position according to one preferred embodiment of the present invention. To secure the locking device on a trailer coupler according to one preferred embodiment of the present invention: seat the ball-shaped member in the socket of a trailer coupler while the lock bracket is in an open position as illustrated in FIG. 2; Rotating the lock bracket back to hover over the trailer coupler; Fasten the lock bracket by inserting the grooved arm into the aperture opening (25); Slide the lock bracket down the apertures to a position that the lock bracket tightly embraces the trailer coupler; Then use the lock mechanism 50 to latch the lock bolt onto the grooved arm. While in the locked condition, the junction between the lock bracket and the retrieve pin is hidden in the aperture of the cylindrical leg (21). This protects the junction from being tempered thus enhances the security.

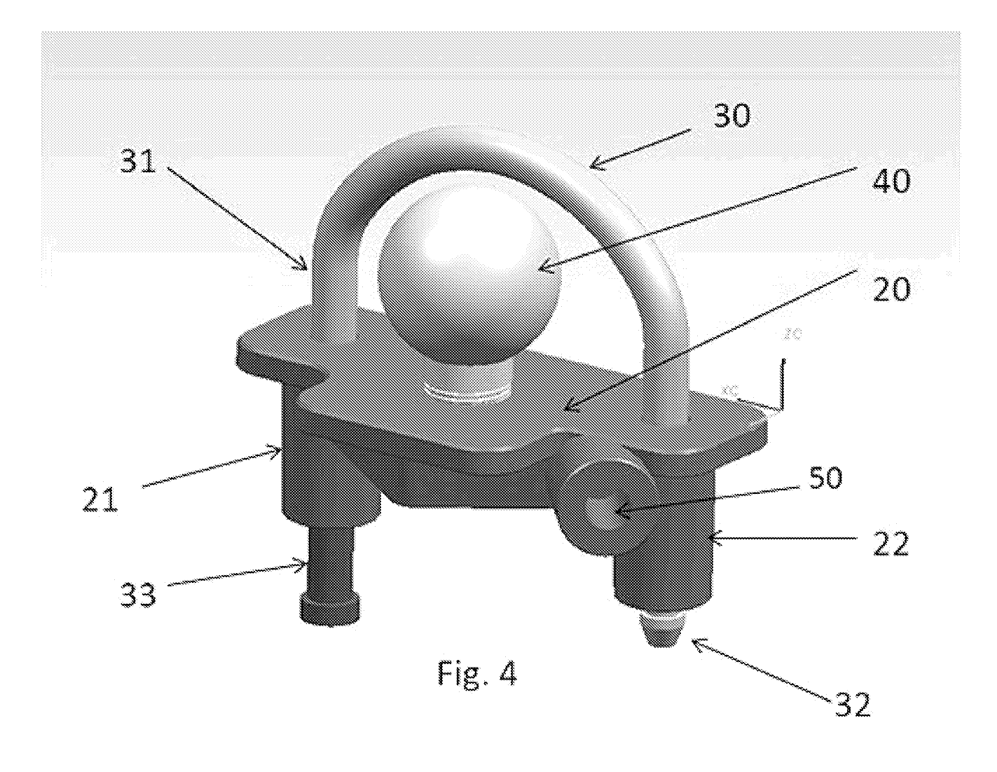

FIG. 4 illustrates a trailer locking device with the lock bracket being pushed down all the way through the apertures of the cylindrical legs according to one preferred embodiment of the present invention. As illustrated in FIG. 4, the length of the cylindrical leg (21) is optimized to provide a strong protection of the junction between the lock bracket and the retrieve pin. Even when the lock bracket is all the way pushed down through the apertures of the cylindrical legs, only the forged-cap end of the retrieve pin falls outside of the cylindrical leg (21), and the junction between the lock bracket and the retrieve pin remains covered inside the cylindrical leg (21).

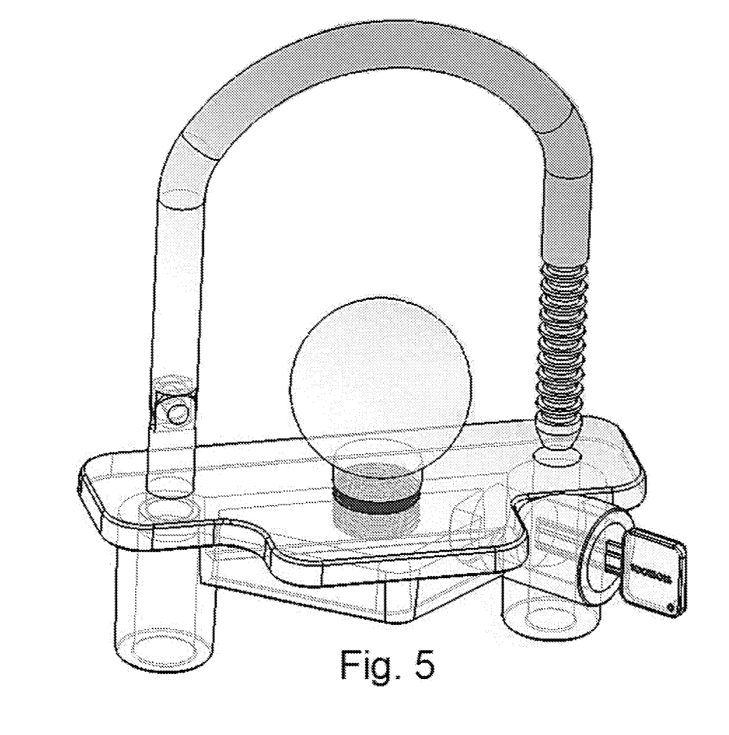

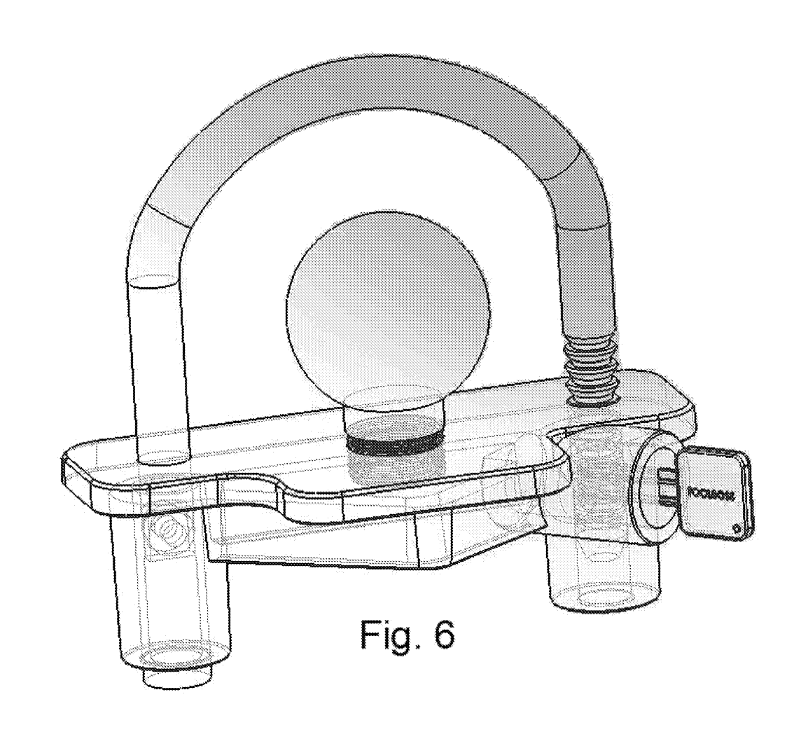

FIGS. 5 and 6 show the perspective drawings of the locking device according to one preferred embodiment of the present invention. They illustrate the linking structure at the junction where the rivet punctures through the notched end of the retrieve pin that sandwiches the insertion end of the lock bracket. They further illustrate the internal blocking ring that causes a reduced diameter of the aperture opening at the top end of the cylindrical leg (21) in order to stop the forged-cap end of the retrieve pin from completely escaping the top aperture opening of the cylindrical leg (21). The figures also show the ball-shaped member screwed into threaded opening (23) in the lock base and the lock mechanism (50) engaging with the spiral grooved arm of the lock bracket.

The structure of the locking device is not limited to what is shown in FIGS. 1-6, but may be further modified in various ways. For example, the hitch ball 40 may be permanently welded on the base. The base and its two legs may be either welded together or die casted in one piece. Instead of using an internal blocking ring at the top end of the cylindrical leg (21) to reduce the diameter of the aperture (24), the aperture (24) may have different internal diameters at different sections: a smaller diameter near the top end of the cylindrical leg (21) to block the retrieve pin from leaving the base; and a larger diameter along other segment of the aperture to allow the retrieve pin (33) sliding along the cylindrical leg (21). Instead of the cylindrical form as illustrated in FIG. 1, the retrieve pin (33) may have a different form or structure capable of sliding along the aperture in the leg (21). For example, a chain with an enlarged end piece may be used in lieu of the cylindrical retrieve pin (33). Furthermore, arm (31) of the lock bracket (30) may be linked to the retrieve pin in many different ways while the linkage remains flexible in order to allow the lock bracket (30) to swing away from or swing close to the ball shaped member (40) when the grooved arm (32) is disengaged. For instance, a ball joint may provide a rotatable connection between the lock bracket (30) and the retrieve pin (33). Or the desired flexibility may be achieved naturally when a chain structured anchoring device is used.

What is claimed is:

1. A locking device used with a coupler to obstruct towing of an object comprising: a base having a first and a second legs extending downward from the base, wherein a first aperture with an opening on the top of the first leg runs lengthwise along the first leg and a second aperture with an opening on the top of the second leg runs lengthwise along the second leg;
a ball-shaped member erecting upright from a top surface of the base;
a lock bracket having a first arm and a second arm, wherein the first arm is always attached to the lock base and the second arm is removable from the second aperture of the second leg.

2. The locking device according to claim 1, further comprising:
a locking mechanism housed in the base for locking the second arm at one or more positions along the second arm in the second aperture.

3. The locking device according to claim 1, wherein when the locking device is in a locked condition, the lock bracket is placed over the ball-shaped member and both the first and the second arms are engaged in their corresponding first and second apertures to interlock with a coupler; whereas when the locking device is in a unlocked condition, the first arm stays attached to the first aperture via an anchoring device, the second arm is removed from the second aperture, and the lock bracket is rotated away from the ball-shaped member to release a coupler.

4. The locking device according to claim 1, wherein the lock bracket is a U-shaped bracket attached to the first aperture in the first leg via an anchoring device.

5. The locking device according to claim 1, wherein the second arm of the lock bracket has a continuous spiral groove.

6. The locking device according to claim 1, wherein the second arm of the lock bracket has multiple ring grooves.

7. The locking device according to claim 1, wherein the second arm of the lock bracket has a series of parallel notches.

8. The locking device according to claim 1, wherein the second arm of the lock bracket has a series of parallel holes.

9. The locking device according to claim 2, wherein the locking mechanism extends or retracts a locking component to engage or disengage with grooves at various positions along the second arm.

10. The locking device according to claim 2, wherein the locking mechanism releases or retracts a pawl to engage or disengage with notches at various positions along the second arm, and the second arm is able to slide in one direction only when the pawl is engaged.

11. The locking device according to claim 1, wherein the first aperture is a through aperture that runs through the first leg, and the length of the first leg is optimized to shield a junction between the first arm and an anchoring device when the locking device is in a locked condition.

12. The locking device according to claim 11, wherein the anchoring device comprises a chain connection and an enlarged end piece.

13. The locking device according to claim 11, wherein the anchoring device comprises a cylindrical retrieve pin with an enlarged cap end.

14. The locking device according to claim 1, wherein the first aperture has a reduced diameter opening at the top end of the first leg.

15. The locking device according to claim 14, wherein the first arm of the lock bracket links to a retrieve pin having a forged cap anchored in the first leg, wherein the forged cap has a diameter larger than the reduced diameter of the first aperture opening at the top end of the first leg so as to prevent the retrieve pin from being removed from the first aperture opening at the top end of the first leg.

16. The locking device according to claim 1, wherein the ball-shaped member is detachable.

17. The locking device according to claim 1, wherein the ball-shaped member is a hitch ball screwed in the lock base and is replaceable by a ball of different size.

18. A method of obstructing towing of an object comprising:
providing a locking device with a base and a lock bracket, wherein the lock bracket is permanently attached to the base, and the base has a ball-shaped member;
positioning the base so that the ball-shaped member is seated in a socket of a coupler,
rotating the lock bracket to hover over the coupler;
inserting one arm of the lock bracket into an aperture opening on the base;
sliding the lock bracket down to a position that the lock bracket snugly embraces the coupler.

19. The method according to claim 18, wherein the lock bracket is attached to the base via an anchoring device sliding through a second aperture on the base.

20. The method according to claim 19, wherein the anchoring device enables the lock bracket rotatable from the base when the locking device is in an unlocked condition.
